(19) United States
(12) Patent Application Publication
(10) Pub. No.: US 2026/0359146 A1
(43) Pub. Date: Nov. 12, 2026

(54) INTENT RECOGNITION AND RENDERING FRAMEWORK

(71) Applicant: Hewlett Packard Enterprise Development LP, Spring, TX (US)

(72) Inventors: Krupesh Mahesh Anadkat, Bangalore (IN); Tathagata Roy, Bangalore (IN); Siddhartha Shankar Sahoo, Bangalore (IN); Ashbin Nasar, Bangalore (IN); Ashish Prabhakar, Bangalore (IN); Anushka Maheshwari, Bangalore (IN)

(21) Appl. No.: 19/257,763

(22) Filed: Jul. 2, 2025

(30) Foreign Application Priority Data
May 8, 2025 (IN) 202541044661

(51) Int. Cl. G06F 9/54; G06F 16/951; G06F 16/958

(52) U.S. Cl. CPC G06F 9/541; G06F 9/543; G06F 9/547; G06F 16/951; G06F 16/986

(57) ABSTRACT

According to an implementation, a system for intent-based user interface orchestration includes a parser that extracts semantic content from HTML elements of a web application, a network interceptor that captures API calls during page interactions, and a metadata store that maintains mappings between extracted intents, APIs, and widgets. The system automatically generates intent candidates from extracted semantic tags, assigns scores based on tag importance, and creates mappings between user intents and corresponding APIs through similarity matching. When a user submits a natural language query, an intent recognition layer identifies the appropriate intent, an LLM orchestrator sends parameter schema to a parameter filler, which processes the parameters, an API executor calls the matched API, and a widget renderer displays the appropriate widget based on the API response.

### BACKGROUND

Enterprise systems typically render static or pre-coded user interface components regardless of specific user needs or intents. As applications become more complex, users often struggle to navigate numerous features and workflows to find relevant information. This challenge can become particularly acute for users, necessitating them to learn the application's structure before effectively utilizing its capabilities.

Current approaches for addressing these navigation challenges may involve lookup tables or map-like data structures to search for features. However, these approaches can produce undesired results when features have multiple references across several workflows. Additionally, the frontend widgets and backend APIs in many systems may be loosely linked, requiring manual or static integration that can lead to implementation challenges and inconsistent user experiences.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a block diagram of a network architecture system that an intent-based widget rendering system can monitor and visualize;

FIG. 2 is a network management interface dashboard that displays widgets designed to provide network monitoring information;

FIG. 3 is a flowchart of a method for automatically generating and maintaining intent-to-API-to-widget mappings;

FIG. 4 is a flowchart of a method for handling user queries and dynamically rendering appropriate widgets based on the intent-to-API-to-widget mappings previously established;

FIG. 5 is a sequence diagram depicting interactions of the intent-based user interface orchestration system, showing the phase (mapping creation) and the runtime phase (query processing and widget rendering);

FIG. 6 is a flowchart of a method for a change detection process;

FIG. 7 is a block diagram of a computing device; and

FIG. 8 is an example data structure representing the format of information stored in the metadata store after the auto crawler extracts semantic cues from a web application interface.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the inventive aspects are described primarily in the context of network management systems with device monitoring interfaces, it should also be appreciated that these inventive aspects may also apply to various consumer or enterprise applications with complex user interfaces. In particular, aspects of this disclosure may similarly apply to financial dashboards, healthcare management systems, customer relationship management platforms, industrial control interfaces, and any software application where users interact with multiple data visualization components.

In implementations, the present disclosure provides an intent-based user interface orchestrator that dynamically maps user intent to appropriate widgets through automated analysis of document object model (DOM) elements and network request interception. Current enterprise systems often present static user interfaces that fail to adapt to specific user needs, requiring users to navigate complex menus and remember feature locations. The intent-based user interface orchestrator addresses these challenges by automatically interpreting user intent and rendering the appropriate widget without manual configuration or domain-specific knowledge.

Aspects of the disclosure disclose a system that operates through a multi-step process that begins with automated analysis of web application pages. A DOM parser tool extracts semantic content from HyperText Markup Language (HTML) elements such as headings and emphasized text, assigning scores based on element importance. A network interceptor captures API calls during page interactions, collecting metadata such as Uniform Resource Locators (URLs) and identifier parameters. The system creates mappings between extracted intents and corresponding Application Programming Interfaces (APIs) through similarity matching.

When users express requests through a query interface, the system can identify the appropriate intent, extract parameters, and execute the matched API call. The widget renderer can display the component that matches the user's intent, preserving interactive elements designed by the product team. This approach eliminates manual mapping between user queries and User Interface (UI) components, allowing the system to automatically adapt to new features and workflows.

The intent-based user interface orchestrator provides advantages over existing approaches. By leveraging the semantic structure of the user interface and intercepting network traffic, the system can infer intent without requiring additional manual input or annotation. The plug-and-play architecture allows integration into enterprise applications without understanding the underlying logic, making it portable across different domains and applications. Additionally, the system can automatically update its mappings when new features are introduced, ensuring scalability as applications evolve.

The intent-based user interface orchestrator enables an intuitive user experience by presenting context-specific visualizations based on user intent rather than generic charts or text responses. For example, when a user asks about network device health, the system can render a comprehensive health dashboard, update a widget on the dashboard, or generate a custom dashboard with interactive elements rather than a simple text summary or basic chart. This approach reduces the learning curve for complex enterprise applications and improves user productivity by eliminating the need to navigate multiple screens to find relevant information. These and additional details are further discussed below.

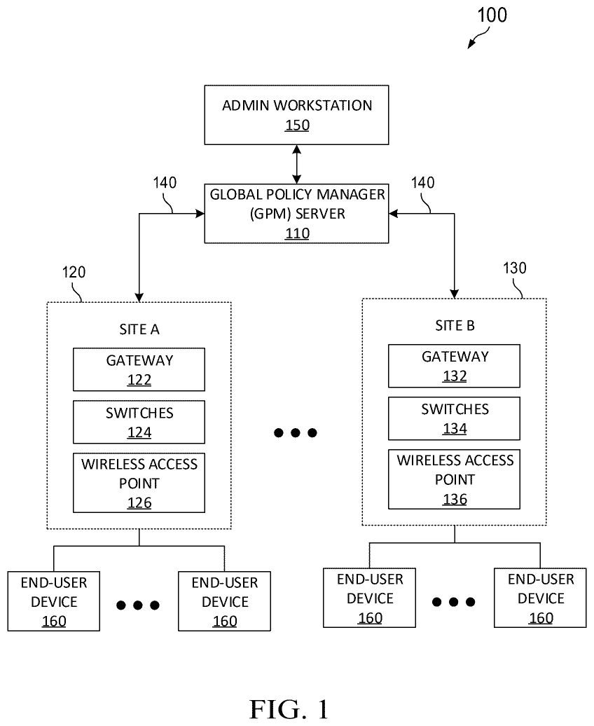

FIG. 1 illustrates a block diagram of a network architecture system 100 that an intent-based widget rendering system can monitor and visualize, based on an implementation of the disclosure. The network architecture system 100 includes a Network Management Server (NMS) 110, multiple enterprise network sites (represented by Site A 120 and Site B 130), network devices at each site (such as gateways 122/132, switches 124/134, and wireless access points 126/136), Wide Area Network (WAN) infrastructure 140, an admin workstation 150, and end-user devices 160.

The NMS server 110 hosts the centralized network monitoring and management functionality. The NMS server 110 can include hardware components and databases for collecting, storing, and processing network telemetry data from all managed devices. These components can include network monitoring agents, performance metrics collectors, device health trackers, and configuration management tools. The NMS server 110 can be configured to handle large-scale network monitoring across diverse environments, ensuring comprehensive visibility throughout the enterprise.

The NMS server 110 can be implemented as a physical server or cluster of servers running a secure, enterprise-grade operating system. It can house a database layer for storing device inventories, performance metrics, health status, and other relevant data for network-wide monitoring.

Each site can represent a distinct geographic location or network segment within the enterprise network. Site A 120 comprises network devices, including one or more gateways 122, one or more switches 124, and one or more wireless access points 126. Site B 130 similarly includes its own set of network devices. These physical devices at each site can generate telemetry data that the NMS server 110 collects and processes, providing the raw information that the intent-based widget rendering system will transform into intuitive visualizations.

The admin workstation 150 can provide access to the network management interface. Network users can use the admin workstation 150 to interact with the NMS server 110, view network status, and manage the infrastructure. This workstation can serve as the point where users experience the intent-based widget rendering system's benefits.

End-user devices 160 coupled to the network can include employee laptops, smartphones, tablets, and IoT devices interacting with the enterprise network. The NMS server 110 can monitor these devices'performance and connectivity status and visualize it through the intent-based widget rendering system.

An intent-based widget rendering system can operate as an interface layer on top of this infrastructure, transforming complex network data into intuitive, context-specific visualizations based on user intent. By understanding the underlying network architecture, the widget rendering system can provide relevant widgets that accurately represent the state and performance of the monitored infrastructure.

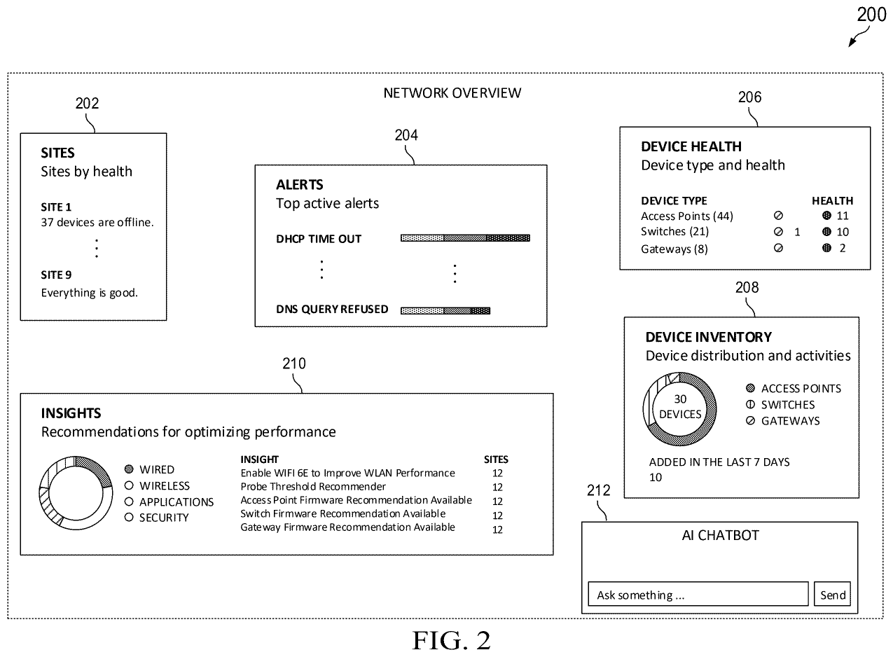

FIG. 2 illustrates a network management interface dashboard 200 that displays widgets designed to provide network monitoring information, according to an implementation of the disclosure. This interface exemplifies the type of complex widgets that an intent-based rendering system can dynamically present based on user queries.

The Sites widget 202 presents site health information with a hierarchical display of sites organized by their health status. The widget includes a “SITES” header followed by “Sites by health” as a descriptive subtitle. Below this, specific site information is displayed with varying text sizes to indicate importance hierarchy, with site names (e.g., “SITE 1”) in larger text than their status descriptions (e.g., “37 devices are offline”). This hierarchical text structure, implemented through, for example, CSS styling, helps users quickly identify problematic sites.

The Alerts widget 204 showcases active network alerts with the “ALERTS” header that identifies the widget's purpose during DOM analysis. The widget displays “Top active alerts” as a subtitle, followed by specific alert types such as “DHCP TIME OUT” and “DNS QUERY REFUSED” with corresponding severity indicators. The varying text sizes and visual indicators help users quickly assess alert severity and prioritize their response.

The Device Health widget 206 summarizes device types and their health status. The “DEVICE HEALTH” header serves as the identifier for this widget during DOM analysis. The widget displays device categories (e.g., Access Points, Switches, Gateways) along with their quantities and health status indicators. Each device category may include hyperlinks that allow users to click and navigate to detailed views showing individual devices within that category. These interactive elements enable users to quickly drill down from summary information to specific details when desired. The tabular format with column headers “DEVICE TYPE” and “HEALTH” creates a visual organization that helps users quickly assess the overall health of their network infrastructure.

The Device Inventory widget 208 displays device distribution information with the “DEVICE INVENTORY” header as its principal identifier. This widget includes a circular chart showing the distribution of device types (Access Points, Switches, Gateways) and additional information about recently added devices. The combination of graphical and textual elements gives users a quick overview of their network composition.

The Insights widget 210 offers recommendations for optimizing network performance with the “INSIGHTS” header as its identifier. This widget includes a circular chart categorizing insights by type (Wired, Wireless, Applications, Security) and a detailed list of specific recommendations. The tabular format with columns for “INSIGHT” and “SITES” helps users understand the recommendation and its scope of applicability.

The AI Chatbot widget 212 provides an interface for users to interact with the system using natural language queries. This widget can include a text input field and a “Send” button, allowing users to express complex intents in their own words. For example, a user might type “list devices on the 6th floor, which are of the model 700 series and find usage of the poor devices” to locate specific devices meeting multiple criteria.

In implementations, the proposed system processes the natural language queries, extracts the intent and parameters, and dynamically renders the appropriate widgets with the requested information, eliminating the need for users to navigate multiple screens or remember specific interface paths.

Each of these widgets represents a carefully designed component created by User Experience (UX) designers based on, for example, data analysis and user research to present information most effectively. Every element within the dashboard, such as the headers, subtitles, data tables, charts, icons, and even the spacing between elements, is deliberately chosen to optimize information comprehension and user workflow. These visual and textual elements serve dual purposes: they communicate information effectively to users while providing rich semantic cues that the DOM parser can identify and analyze.

The styling hierarchy within each widget, from principal headers to secondary labels to data values, creates a visual language that users and the parsing system can interpret. For example, in the Device Health widget 206, the column headers “DEVICE TYPE” and “HEALTH” organize user information and provide contextual markers that help the parser understand the relationship between device categories and their status indicators. Similarly, the graphical elements in the Device Inventory widget 208 and Insights widget 210 convey information visually to users while representing structured data that the system can interpret.

These designs are merely examples and not necessarily limiting; the intent-based widget rendering system can work with any widget design. The semantic structure embedded throughout the interface, through consistent use of text styles, visual elements, and organizational patterns, enables the parser to extract meaningful intents from the interface. The approach to semantic markup allows the intent-based rendering system to accurately map user queries to the appropriate widgets and their specific features, creating an experience where users can request information in natural language and receive precisely the visualization they need.

When widgets are rendered in response to a natural language query, the proposed system preserves all interactive elements such as hyperlinks, hover states, and other navigational features present in the original widget design. For example, if a user asks “show me devices with poor health status,” the system not only renders the appropriate Device Health widget with the requested filtering, but also maintains all the interactive hyperlinks that allow the user to click on specific device categories to access detailed information. This preservation of interactive elements ensures that users maintain the same ability to navigate through information hierarchies regardless of whether they accessed the widget through traditional navigation or a natural language query. The interactive nature of the rendered widgets provides a consistent user experience while delivering the specific information requested through the query.

Existing user interface systems face limitations when addressing user intent in network management contexts. These systems typically lack intent awareness, rendering widgets based on static logic rather than dynamically interpreting user needs. When a user expresses the previous query (discussed concerning the AI Chatbot widget 212), traditional Network Management System (NMS) products display a generic list of all devices, requiring users to manually filter for floor location, model type, and health status, then navigate to a separate workflow to examine device usage.

Some systems attempt to create static mappings between intents and UI widgets, but these mappings deteriorate as workflows become complex or new features are introduced. Fulfilling complex user intents typically requires combinations of multiple APIs with numerous permutations, making static mapping approaches increasingly challenging to maintain. While Language Learning Model (LLM) systems can execute API sequences and provide summaries, they often fall short in network usage visualization scenarios where users need specific visual representations with embedded logic rather than text summaries or generic charts.

Current approaches may understand intent and execute APIs, but fail to render the appropriate widget that matches specific requirements and usage patterns. They cannot leverage the carefully crafted formats that UX designers have identified to improve comprehension and workflow efficiency, such as the specialized layouts, information hierarchies, and visual elements demonstrated in the example dashboard widgets, which have been designed to present complex network information in the most intuitive and actionable manner.

The architectural separation between frontend widgets and backend APIs can create operational challenges. This separation necessitates manual integration approaches where developers explicitly code relationships between UI elements and their corresponding API endpoints. Such implementations tend to be brittle, breaking when either component changes independently. This separation also leads to redundant logic being implemented in multiple places—similar rules may be encoded separately in frontend widgets and backend services, creating maintenance burdens and potential inconsistencies.

As systems evolve, this disconnect can become increasingly problematic, requiring extensive reconfiguration of mappings. The lack of dynamic, automated connections between user interfaces and underlying data services limits adaptability to changing requirements and the ability to present information in formats optimized for operational clarity.

Without sophisticated intent-based mapping capabilities, systems typically default to standard visualization components such as pie charts or line graphs, regardless of whether these formats effectively communicate the specific information sought. This one-size-fits-all approach fails to account for the varied requirements of different data types and use cases in complex domains like network management.

When users request device performance or network health information, systems may generate generic charts showing basic metrics, even when specialized visualizations would better serve their needs. These placeholder widgets often omit critical contextual information, interactive elements, and domain-specific visual cues that make data actionable. For example, instead of rendering a comprehensive device health dashboard with color-coded status indicators and drill-down capabilities, a system might produce a simple pie chart showing healthy versus unhealthy devices without the context for effective decision-making.

The misalignment between user intent and visualization output diminishes utility, forcing users to mentally translate generic visualizations into domain-specific insights. This cognitive burden reduces productivity and represents a limitation preventing systems from delivering the tailored, information-rich visualizations that network users require for efficient monitoring and troubleshooting.

The absence of an automated mapping mechanism to bridge the semantic gap between user interfaces and underlying APIs presents another significant challenge. Without this capability, no systematic way exists to extract meaning from DOM elements and connect this meaning to appropriate network layer APIs. This necessitates organizations to rely on manual, labor-intensive processes to establish and maintain these connections.

Mapping UI elements to APIs manually creates challenges. For example, it requires extensive domain knowledge from developers, introduces a high risk of human error when linking numerous components to their corresponding endpoints, and creates a maintenance burden that grows exponentially as applications scale. Each new feature or modification requires careful updates to these mappings.

Without automation, effective reuse of existing UI-API relationships across different parts of the application becomes difficult. Developers typically recreate mappings from scratch rather than leveraging existing patterns, wasting resources and increasing the likelihood of inconsistencies in how similar data is presented and processed throughout the system.

The inability to easily orchestrate complex workflows spanning multiple UI components and API calls transforms what should be straightforward configuration into complex programming challenges. This constraint limits adaptability to evolving requirements and user needs, resulting in less flexible, less maintainable applications that fail to leverage the full potential of interface design and API capabilities.

Users of systems without dynamic mapping capabilities encounter disjointed workflows that fail to maintain contextual continuity across different functional areas. This fragmentation forces users to mentally track progress and manually transfer context between disconnected interface components, creating cognitive overhead that detracts from their responsibilities.

This workflow fragmentation manifests when users navigate through multiple screens to complete what should be a single logical operation, repeatedly entering the same criteria at each step. After identifying devices with poor health status in one view, users have to separately navigate to performance monitoring tools and re-specify the same devices to analyze usage patterns. This results in wasted time and introduces opportunities for errors in how information is filtered and presented.

Without dynamic mapping, traditional systems present the same rigid interface to all users regardless of their roles or expertise levels. For example, network administrators with different responsibilities and technical backgrounds all encounter identical interface structures that don't adapt to their specific needs or working patterns. For example, a senior network engineer and a junior IT support technician see the same dashboard layout and navigation options, even though their responsibilities and expertise differ significantly. This one-size-fits-all approach prevents systems from providing streamlined experiences tailored to common tasks for specific roles or offering appropriate guidance for less familiar operations based on user expertise.

Traditional systems also fail to attach a persona to user queries, resulting in universal responses that don't consider who is asking the question. Different users submit identical queries and receive identical results regardless of their role, access level, or expertise. This approach ignores the context of who needs the information and for what purpose. A more effective approach would deliver persona-based results that adapt to the user's identity and permissions. For example, when querying about network performance issues, a super-user with administrative privileges should receive comprehensive diagnostic information with deep technical details and access to configuration controls. In contrast, a regular user might receive a simplified summary with limited access to sensitive information or system controls. By failing to incorporate user personas into query processing, traditional systems miss opportunities to provide appropriately scoped and relevant information tailored to each user's needs and permissions.

These inconsistent experiences lead to poor user adaptation and resistance to system adoption. Users develop workarounds, often using external tools or manual processes to bridge workflow gaps. These adaptations further fragment the operational environment and undermine the system's value. As features are added without coherent integration into existing workflows, the user experience becomes increasingly fragmented, creating a spiral of complexity that makes the system more challenging to use effectively.

The lack of plug-and-play support for intent-based widget rendering creates significant implementation barriers and maintenance challenges. No existing solution can automatically observe interfaces, adapt to their structure, extract meaningful intents, map them to appropriate APIs, and deploy the resulting flows without extensive manual intervention. This necessitates organizations to invest substantial resources in custom development efforts requiring deep rule coding, explicit static mappings, and meticulous setup procedures for each implementation or modification.

Organizations cannot escape extensive manual work even when leveraging advanced technologies like LLMs. While LLMs may help interpret queries, they cannot independently navigate the complex relationships between intents, backend APIs, and specialized widgets. Developers have to explicitly program these relationships, creating connections that require ongoing maintenance as the system evolves.

This manual approach creates a scaling problem as applications grow more complex. The effort to maintain intent-to-widget mappings increases exponentially with additional features, workflows, and visualizations. Each new widget requires careful integration, with developers manually defining how it relates to user intents and which APIs it should invoke. Similarly, new APIs require updates to numerous mapping tables or code sections to ensure proper widget rendering.

The absence of plug-and-play capability impedes organizational agility. When requirements change or new visualization needs emerge, organizations cannot quickly adapt their interfaces; instead, they have to undertake time-consuming development cycles to implement and test new mappings. This delay between identifying needs and delivering solutions undermines the system's ability to respond to evolving requirements and expectations, limiting its value as a strategic tool.

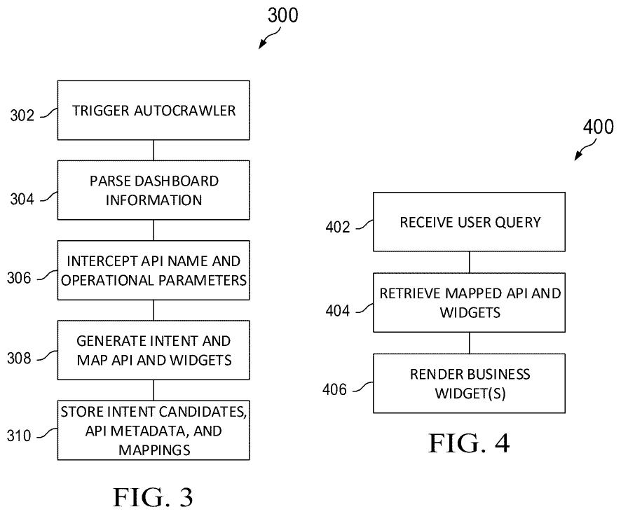

FIG. 3 illustrates a flowchart of a method 300 for automatically generating and maintaining intent-to-API-to-widget mappings, according to an implementation of the disclosure. In various implementations, the method may include additional or fewer steps, or the steps may be performed differently than illustrated.

At step 302, the process begins with triggering an auto-crawler. In implementations, the automated crawler systematically visits all pages of the web application to gather information about the user interface structure. The auto-crawler can be triggered through various mechanisms, including when a tracker (e.g., a change tracker) detects version changes in the application, in response to a new build deployment, or through direct user intervention. This operation may be performed through software components designed for automated web crawling.

This initial step ensures that the system maintains current knowledge of the application's structure even as it evolves. The auto-crawler's extracts semantic content from the user interface, such as headers, emphasized text, and placeholders, to infer intent from the UI structure without requiring human input. This approach forms the foundation of the plug-and-play system, which eliminates manual wiring by leveraging the existing UI structure and integrated logic that UX designers have already incorporated into the interface, where titles and descriptions of widgets often reflect their intended purpose.

At step 304, the dashboard information is parsed through a parser, such as a Document Object Model (DOM) parser. During this phase, the system examines each widget in the application interface. For each widget, the parser extracts text content from semantic tags, including heading elements (e.g., h1, h2), emphasis elements (e.g., b, strong), placeholders, and other structural elements (e.g., span, div, p). The text extraction captures the semantic richness of the user interface, preserving the information hierarchy and emphasis that interface designers have incorporated into the interface. This intent extraction process identifies and derives meaningful intent from the widget by analyzing these tags, without requiring any enterprise-specific knowledge or manual mapping. This parsing operation may be implemented through various software approaches for DOM analysis.

At step 306, the system intercepts API names, operational identifiers (operational names), and parameters. In an implementation, the system listens to API calls during page load or user interaction, capturing metadata about each API, such as its name, operation ID, query structure, parameters (e.g., which are mandatory and their data types), and response schema. This network interception captures API requests in real time to record, for example, API URLs, operation IDs, and parameters without requiring manual API documentation.

At step 308, the system generates intent candidates and establishes mappings to APIs and widgets. The parser can create intent candidates from extracted semantic tags, assigning scores based on the importance of each tag type. For example, text within “h1” tags may receive higher scores than text within standard paragraph elements, reflecting the greater semantic significance of headings in conveying the intent of interface components. This intent generation and scoring may be performed through various computational approaches.

At step 310, the information collected from steps 306 and 308 can be stored in the database alongside the previously extracted intent data, creating mappings between user interface elements and their corresponding backend services. This interception functionality may be implemented through various network monitoring approaches.

In an implementation, the system generates meaningful intent names from the extracted UI text and stores the intents in a database. The process can perform intent-API mapping by automatically matching the extracted intent to the nearest operation identifier (ID) or API name using, for example, semantic similarity algorithms such as cosine similarity. When the similarity score exceeds a defined threshold, the system creates a mapping between the intent, API, and widget. This automated mapping process requires zero hardcoding and automatically adapts to changes in the application's structure and functionality. These mapping operations may be implemented through various text analysis and similarity comparison techniques.

Throughout this process, extracted information flows into the database, which can serve as the repository for the system. Typically implemented as a combination of graph and document models, the database persistently stores the UI-extracted intents, API metadata, widget types and their bindings, URLs, and component types. As part of this process, the system registers each widget with a unique identifier and type, and links the widget to its corresponding intent and API.

The registration ensures that the correct widget is rendered when a matching intent is detected, rather than displaying a random placeholder or default chart that may not effectively communicate the specific information the user seeks. The database's goal is to maintain these mappings over time, providing the foundation for the system's ability to dynamically respond to user intents by rendering the appropriate widgets. These storage and registration operations may be implemented through various database and data management techniques.

Method 300 represents a fully automated approach to building and maintaining the semantic connections between user interface elements, intents, and backend services. By systematically crawling the application, parsing its structure, generating intent mappings, and intercepting API details, the system creates an understanding of the application without requiring manual configuration or domain expertise.

The automated process enables the intent-based user interface orchestration system's plug-and-play nature, allowing it to adapt to changes in the application and respond accurately to user queries without requiring any enterprise-specific knowledge, hardcoding, or manual mapping. The widget mapping and registration ensure that user queries result in the display of precisely the right widget—one that has been specifically designed to present the requested information in the most effective and contextually appropriate manner.

FIG. 4 illustrates a flowchart of a method 400 for handling user queries and dynamically rendering appropriate widgets based on the intent-to-API-to-widget mappings previously established, according to an implementation of the disclosure. In various implementations, the method may include additional or fewer steps, or the steps may be performed differently than illustrated.

At step 402, the process begins with receiving a user query. In implementations, the system accepts natural language input from interfaces such as chatbots or search fields. The system extracts the underlying intent from the query, and identifies any parameters the user specifies.

For example: When a user enters a query like “List devices on the 6th floor, which are of the model 700 series and find usage of the poor devices,” the system can detect the intent related to device listing and extracts parameters such as location (6th floor), model type (700 series), and condition (poor health).

Another example: When a user asks, “Show me poor health devices from site 6,” through a chatbot interface, the system can detect the intent of finding devices and extract metadata parameters such as site identifier (site 6) and device condition (poor health).

This intent recognition process transforms natural language queries into structured requests that can be matched to appropriate APIs and widgets. In an implementation, the intent recognition layer accepts natural language input from chatbots or search interfaces and matches this input to stored intents using similarity scoring algorithms. The aim is to accurately identify which flow the user is trying to trigger, ensuring that the system responds with the most relevant information and visualizations. This operation may be performed through various natural language processing and intent recognition techniques, for example.

At step 404, the system retrieves the mapped APIs and widgets that correspond to the identified intent from step 402. Using the previously established mappings stored in the database, the system can identify which APIs are to be called to fulfill the user's request. A parameter filler can extract parameters from the user input and uses defaults or, in some implementations, may prompt the user for missing parameters. This ensures valid API calls can be made with minimal user effort, enhancing the system's usability while maintaining accuracy.

The system can construct the appropriate API request, execute the call to the backend service, and receive the response data. An API executor can execute the matched API call with the correct parameters and receive and parse the response. The goal is to fetch live data based on the user's intent, ensuring that visualizations reflect current information. In implementations, the system matches the API with the stored intent using the API name and operation ID, binds the parameters extracted in the previous step, and makes the network request.

For example, when processing the query about poor health devices from site 6, the system matches the intent of devices and parameters like poor health and site identifier, and the corresponding API is fired with these parameters.

This orchestration process can holistically understand the user request, retrieve the correct widget mappings, and execute the flow dynamically without requiring predefined scripts for each possible query. In implementations, an LLM orchestrator can control the flow from intent recognition to widget execution, calling APIs, binding parameters, and controlling logic. It can manage parallelism, synchronous, and asynchronous behavior, and return results to the intent recognition layer. The retrieval and execution operations may be implemented through various orchestration and parameter handling approaches.

At step 406, the system renders the appropriate widget or set of widgets based on the API response and intent mapping. A widget renderer can dynamically inject and display the correct widget in the UI and bind API response data to the widget structure. The aim is to present a context-aware, enterprise-specific component that matches the user's intent, rather than generic visualizations. In implementations, the system shows the widget or set of widgets mapped to the API's intent metadata, ensuring that the correct set of widgets is rendered and no placeholder charts or random components are displayed.

The system can match the widget type and component with the stored component designed to display this specific type of information. It binds the API response data to the widget structure, populating the widget with the data values returned by the API. It renders the widget within the application interface.

Because the widget reference is known to the application through the previous mapping process, the application can seamlessly integrate the widget without errors or compatibility issues, including preserving all interactive elements such as hyperlinks that enable diving into further details. When a user asks a question about device health, the rendered widget not only displays the summary information but also maintains the clickable elements that allow navigation to more detailed views, just as they would appear in the traditional interface. This approach ensures that users receive the correct widget designed for their intent, with all its interactive capabilities intact, rather than generic placeholders or standard charts that may not effectively communicate the information or provide pathways to more detailed data.

Method 400 represents the runtime execution flow of the intent-based user interface orchestration system, complementing the setup and mapping process illustrated in method 300. Together, these methods enable a fully automated, self-maintaining system that can interpret user intents, execute the appropriate backend services, and render the right widgets to address the user's needs.

The system's ability to dynamically respond to natural language queries with contextually appropriate visualizations significantly enhances user productivity by eliminating the need to navigate complex application interfaces or remember specific feature locations. Instead, users can express what they want to know, and the system delivers the most effective visualization of that information.

The intent-based rendering approach of method 400 overcomes the limitations of traditional rigid interfaces by dynamically adapting to user roles and expertise levels. Unlike, for example, LLM-driven systems that display widgets but struggle to represent role-based access control (RBAC) through persona-driven presentations (without considering access permission), this method can tailor visualizations based on user personas attached to queries. When a user submits a query, the system can incorporate user role information as an additional parameter during intent identification and widget selection.

For example, when a senior network engineer and a junior IT support technician submit identical queries about network performance, the system can render different widgets with varying levels of detail and control options appropriate to each user's expertise and permissions. The senior engineer might receive diagnostic widgets with advanced configuration controls, while the junior technician sees a simplified visualization with guided troubleshooting options.

Advantageously, the persona-based rendering ensures that super-users with administrative privileges receive detailed information with deep technical insights and full access to system controls, while regular users receive appropriately scoped information with limited access to sensitive data or configurations.

By dynamically mapping user queries to role-appropriate widgets, method 400 delivers streamlined experiences tailored to common tasks for specific roles while offering appropriate guidance for less familiar operations based on user expertise. This context-aware approach ensures that users receive the information they need in a format optimized for their specific requirements and permissions.

The intent-based rendering approach of method 400 enables the system to deliver customized dashboards that precisely match user needs while maintaining the carefully crafted design principles established by UX designers. Rather than forcing users to navigate through generic interfaces, the system dynamically assembles dashboards populated with the exact widgets to address the specific query. These widgets appear in their original form as designed by UX experts, with all interactive elements, visual hierarchies, and information architectures preserved intact. The system doesn't compromise on design quality when rendering results—it simply identifies and presents the most relevant pre-designed components.

When a user submits a query like “Show me network performance issues across all sites with critical alerts,” the system does not generate generic charts or text summaries. Instead, it identifies the appropriate widgets—such as the Alerts widget, Device Health widget, and Insights widget—and arranges them in a cohesive dashboard that provides a comprehensive view of the requested information. Each widget maintains its original design language, including color-coding for severity, interactive elements for drilling into details, and information hierarchies that emphasize the most desirable data points. This approach ensures that users benefit from the thoughtful design decisions made by UX professionals while receiving the information they requested.

The rendering process can also adapt the dashboard layout based on the complexity of the query and the number of widgets to address it. The system might render just that component with appropriate emphasis for simple queries that can be answered with a single widget. For complex queries requiring multiple data points, it can arrange several widgets in a logical layout that facilitates understanding the relationships between different aspects of the data. This flexibility allows the system to provide appropriately scaled responses ranging from focused, single-widget displays to comprehensive multi-widget dashboards, all while maintaining the design integrity of each component. By combining the power of intent recognition with respect for established design principles, method 400 delivers customized yet professionally designed interfaces that adapt to user needs without sacrificing usability or visual coherence.

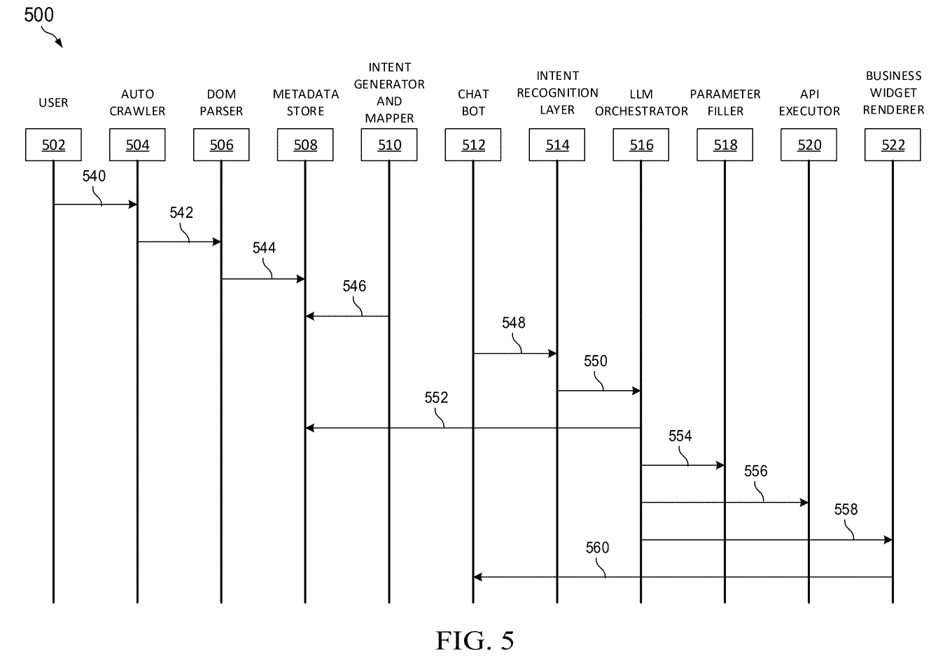

FIG. 5 illustrates a sequence diagram 500 depicting interactions of the intent-based user interface orchestration system, showing the phase (mapping creation) and the runtime phase (query processing and widget rendering), according to an implementation of the disclosure. The diagram includes a user 502, auto crawler 504, DOM parser 506, metadata store 508, intent generator and mapper 510, chatbot 512, intent recognition layer 514, LLM orchestrator 516, parameter filler 518, API executor 520, and widget renderer 522.

The sequence begins with interaction 540, where the user 502 triggers the auto crawler 504. In implementations, interaction 540 can correspond to step 302 in method 300, where the auto crawler 504 is activated to systematically visit the pages of the web application. The auto crawler can be triggered through various mechanisms, including when a change tracker detects version changes in the application, in response to a new build deployment, or through direct user intervention.

Following the activation of the auto-crawler, interaction 542 shows the DOM parser 506 parsing semantic elements such as heading tags (e.g., h1, h2), emphasis elements (e.g., b), and placeholders from the web application pages. In implementations, interaction 542 can correspond to step 304 in method 300, where the dashboard information is parsed to extract text content from semantic tags. This parsing operation can capture the semantic richness of the user interface, preserving the information hierarchy and emphasis that interface designers have incorporated.

In interaction 544, the DOM parser 506 sends the extracted semantic content to the metadata store 508, which generates intent candidates and establishes mappings to APIs and widgets. In implementations, interaction 544 can correspond to step 306 in method 300, where the system creates intent candidates from extracted semantic tags, assigning scores based on tag importance, and performs intent-API mapping using similarity algorithms. The metadata store serves as the central repository for these mappings.

In addition to generating intent candidates and establishing API mappings, the system can register each widget with a unique identifier and type, linking the widget to its corresponding intent and API. This registration process ensures that the correct widget is rendered when a matching intent is detected. The registration information stored in the metadata store 508 enables the widget renderer 522 to precisely identify which widget to display during interaction 560.

Interaction 546 shows the intent generator and mapper 510 intercepting, for example, API names, operation IDs, and parameters, and storing this information in the metadata store 508. In implementations, interaction 546 can correspond to step 308 in method 300, where the system listens to API calls during page load or user interaction to capture metadata about each API. This network interception creates comprehensive mappings between user interface elements and their corresponding backend services.

The sequence transitions to the runtime phase with interaction 548, where the user 502 submits a query through the chatbot 512. In implementations, interaction 548 can correspond to step 402 in method 400, where the system receives a natural language query from the user. The chatbot forwards this query to the intent recognition layer 514 for processing.

In interaction 550, the intent recognition layer 514 processes the query and sends it to the LLM orchestrator 516. The LLM orchestrator receives the one or more intents and understands the synchronous/asynchronous behavior for processing. In implementations, interaction 550 can correspond to the intent recognition process described in step 402 of method 400, where natural language queries are transformed into structured requests.

Interaction 552 shows the LLM orchestrator 516 looking up the closest matching intent and mapped API in the metadata store 508. In implementations, interaction 552 can correspond to step 404 in method 400, where the system retrieves the mapped APIs and widgets corresponding to the identified intent using the previously established mappings stored in the database.

In implementations, during interaction 552 when the LLM orchestrator 516 looks up the closest matching intent, the system can employ semantic similarity algorithms such as cosine similarity with a defined threshold. The system creates a match when the similarity score between the user query and a stored intent exceeds this threshold. This approach, described in method 300, allows for flexible intent recognition that can handle variations in how users express their requests while accurately identifying their underlying intent.

In interaction 554, the LLM orchestrator 516 sends the parameter schema to the parameter filler 518, which extracts and fills the parameters. In implementations, interaction 554 can correspond to the parameter filling aspect of step 404 in method 400, where the system extracts parameters from user input and applies default values where appropriate to ensure valid API calls with minimal user effort.

Interaction 556 shows the LLM orchestrator 516, after interaction 554, sending the filled parameters to the API executor 520, which executes the matched API call with the correct parameters. In implementations, interaction 554 can correspond to the API execution aspect of step 404 in method 400, where the system constructs and executes the appropriate API request to fetch live data based on the user's intent.

In interaction 558, the LLM orchestrator 516 sends the API response to the widget renderer 522. This represents the completion of the API call and the transition to the rendering phase described in step 406 of method 400.

In some implementations, a single user query processed in interaction 548 may require data from multiple APIs to fulfill. In such cases, the LLM orchestrator 516 can orchestrate parallel or sequential execution of multiple API calls during interaction 556 and interaction 558, coordinating the results before sending them to the widget renderer 522. This capability enables the system to handle complex user intents that span multiple data domains or functional areas.

Interaction 560 shows the widget renderer 522 rendering the matched widget and sending the result back to the chatbot 512. In implementations, interaction 560 can correspond to step 406 in method 400, where the system renders the appropriate widget based on the API response and intent mapping, ensuring that users receive the correct widget designed for their intent rather than generic placeholders or standard charts.

While not explicitly shown in the sequence diagram 500, the system can implement an automatic update mechanism, as described in step 408 of method 400. In implementations, after rendering widgets, a change tracker component can continuously monitor for changes in the DOM structure or identify new API calls through continuous integration/continuous deployment processes. When changes are detected, this component can trigger interaction 540 again, restarting the auto-crawling process to refresh the metadata store with updated mappings. This ensures that the intent-to-API-to-widget mappings remain current even as the application evolves, without requiring manual intervention.

The sequence diagram 500 provides a comprehensive view of how the components of the intent-based user interface orchestration system interact to achieve both the setup of intent-to-API-to-widget mappings (method 300) and the runtime processing of user queries (method 400).

This visualization demonstrates the system's plug-and-play nature. It shows how it can automatically build mappings during setup and leverage them during runtime to deliver contextually appropriate visualizations in response to natural language queries.

Although specific software layers, modules, or components are identified as performing particular steps in the diagram, it should be appreciated that this division of tasks is to simplify the discussion. The instructions associated with each component are not necessarily limiting. In various implementations, these tasks may be combined or redistributed to be performed by a single instruction set executed by one or more processors.

Accordingly, the interactions and components discussed represent a possible implementation approach, and other variations or implementations may achieve similar results without necessarily following the exact interaction patterns or component structure described here. The principles of intent extraction, API mapping, and context-aware widget rendering remain applicable across different architectural approaches.

The sequence diagram 500 illustrates several aspects of the intent-based user interface orchestration system. The system requires zero hard coding; no manual mapping is necessitated between user intent, APIs, and widgets. Instead, the system auto-discovers and builds these relationships during runtime through DOM and network analyses.

Rather than building logic relevant to an entity or enterprise from scratch, the system leverages the existing UI design and its integrated logic already embedded in the front end. This approach eliminates the need for logic development, as shown in the sequence, where the system extracts meaning directly from the UI structure and connects it to backend functionality.

The plug-and-play architecture demonstrated in the sequence diagram allows the system to be integrated into any enterprise UI without understanding the underlying logic. It works by passively observing and interpreting UI behavior and API interactions, as shown in the initial setup phase.

The automated Intent-API-Widget mapping is evident throughout the sequence, where user queries are seamlessly transformed into appropriate widget renderings. The system dynamically links user intent to APIs and renders the correct widgets using parsing of DOM elements and intercepted API metadata.

Since the system requires no domain-specific training or hard-coded rules, it is reusable across domains and applications. The sequence diagram shows a domain-agnostic approach where the system relies on structural patterns and semantic similarities rather than predefined domain knowledge.

The system ensures precision in widget rendering, rendering the correct set of widgets—not placeholder charts or random components. This precision stems from the careful mapping and registration processes established earlier in the sequence.

The system readily adapts to new features, and the automatic update mechanism detects changes and triggers recrawling. As new workflows, APIs, or widgets are introduced, the system automatically detects them and integrates them into the intent mapping layer without reconfiguration or manual intervention, making it highly scalable and future-proof.

Throughout the sequence, the interactive nature of widgets is preserved intact. When the widget renderer 522 renders widgets in interaction 560, interactive features such as hyperlinks or hover functionality are maintained exactly as designed in the original UI, ensuring a seamless and fully functional user experience.

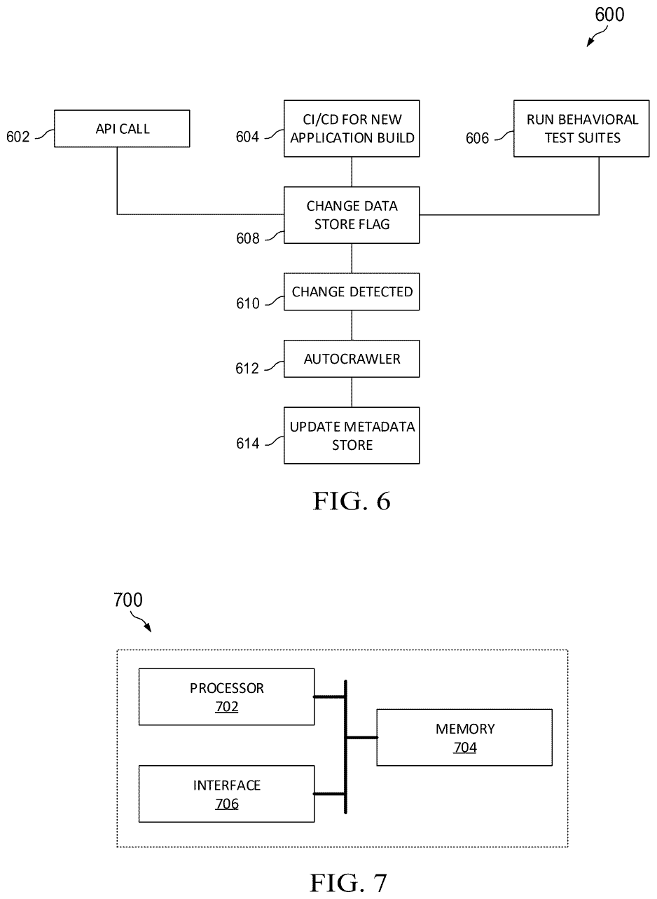

FIG. 6 illustrates a flowchart of a method 600 for a change detection processor, according to an implementation of the disclosure. Method 600 shows three examples that can initiate the automatic update process for the intent-based user interface orchestration system. These examples are provided for illustrative purposes, and it should be understood that in other implementations, various other events, triggers, or conditions can initiate the automatic update process beyond those specifically depicted. The specific triggers shown represent common scenarios but are not intended to limit the scope of possible update initiation mechanisms. In various implementations, the method may include additional or fewer steps, or the steps may be performed differently than illustrated.

At step 602, an API call can serve as a manual trigger for the update process. This allows administrators or developers to explicitly request a refresh of the system's mappings when desired.

At step 604, continuous integration/continuous deployment (CI/CD) processes for a new application build can trigger the update process when changes are detected in the application code.

At step 606, running behavioral test suites during the testing phase of the main build can initiate the update process. These three triggers represent different scenarios in which the application structure or behavior might change, necessitating an update to the intent-API-widget mappings.

When any of these triggers occur, the system proceeds to step 608, where a change data store flag is set. This flag signals that a potentially significant change has occurred in the application that might affect the validity of the existing mappings. The change data store flag provides a centralized mechanism for tracking changes from multiple sources, allowing the system to respond appropriately regardless of how the change was initiated.

At step 610, a change tracker component that subscribes to change events detects the change based on the flag status. This component continuously monitors the change data store flag and initiates the update process when the flag indicates that a change has occurred. This approach ensures that the system can respond promptly to changes without requiring constant polling or manual intervention.

Once a change is detected, the system proceeds to step 612, where it triggers the auto-crawler to perform the operations described in method 300 (FIG. 3). The auto-crawler systematically visits pages of the web application, parses dashboard information, generates intent candidates, intercepts API calls, and establishes mappings between intents, APIs, and widgets. This comprehensive crawling process ensures that any new or modified elements in the application are properly captured and incorporated into the system's understanding.

At step 614, the system updates the metadata store with the refreshed information gathered by the auto-crawler. This includes updated intent candidates, API metadata, mappings, or a combination thereof, depending on what has changed in the application. The metadata store now contains current information that reflects the application's current state, ensuring that subsequent user queries will be processed correctly.

Method 600 enables the intent-based user interface orchestration system to automatically maintain its mappings as the product evolves, ensuring the system remains effective without requiring manual intervention. This automatic update mechanism ensures that the intent-to-API-to-widget mappings remain current even as the application changes through development iterations, feature additions, or structural modifications. By implementing this change detection and update process, the system can seamlessly adapt to application changes. It maintains the ability to accurately interpret user intents and render appropriate widgets regardless of how the underlying application evolves over time.

The change detection and update operations may be implemented through various change tracking and version management approaches, allowing the system to integrate with existing development workflows and tools. This flexibility ensures that the intent-based user interface orchestration system can operate in diverse development environments while maintaining accurate mappings between user intents, APIs, and widgets.

FIG. 7 illustrates a block diagram of a computing device 700, according to certain implementations of the disclosure. The intent-based user interface orchestration system described herein can be implemented using such computing devices. Computing device 700 includes a processor 702, a memory 704, and an interface 706, which may (or may not) be arranged as shown. Computing device 700 may include additional components not shown, such as a power supply to provide power to the computing device 700.

Computing device 700 can be, for example, a server (e.g., a blade-server in a blade-server chassis, a rack server in a rack, etc.), a desktop computer, a mobile device (e.g., laptop computer, smartphone, a personal digital assistant, tablet computer), a network management server, a cloud-based computing resource, a virtual machine, a virtualized computing environment, or any combination of such devices.

In some implementations, computing device 700 can be the system that implements all the intent-based user interface orchestration system features. In other implementations, computing device 700 can represent a network user's computer that interfaces with the system to perform searches and view the widgets displayed in FIG. 2, or a cloud-based server that the user accesses to utilize the system's capabilities.

Although FIG. 7 shows a single computing device, it should be understood that the operations disclosed herein can be performed by multiple computing devices operating at the same or remote locations relative to each other, such as in a distributed or cloud computing environment. The computing device 700 may serve as the platform for implementing the intent-based user interface orchestration system, including the auto crawler, DOM parser, intent generator and mapper, metadata store, intent recognition layer, LLM orchestrator, parameter filler, API executor, and widget renderer components described in previous figures.

In an implementation, processor 702 is an integrated circuit, a single-core processor, a microcontroller, or a multi-core processor for processing instructions. Processor 702 may be a general-purpose processor configured to execute program code implementing the methods described in FIGS. 3, 4, and 5. The processor 702 may execute instructions that implement the auto-crawling process, DOM parsing, intent generation and mapping, API interception, intent recognition, parameter filling, API execution, and widget rendering. These operations may be performed sequentially or in parallel, depending on the capabilities of the processor 702 and the specific implementation approach.

In an implementation, memory 704 is volatile memory, non-volatile memory, or both. Memory 704 may include random-access memory (RAM), cache memory, persistent storage, a hard disk, or flash memory. Memory 704 includes non-transitory computer-readable storage media for storing data and instructions. Memory 704 can serve as the metadata store described in previous figures, storing the extracted intents, API metadata, widget types and their bindings, URLs, and component types. Memory 704 maintains these mappings over time, providing the foundation for the system's ability to respond dynamically to user intents by rendering the appropriate widgets. Memory 704 is configured to store instructions to be executed by processor 702 to perform the methods disclosed herein, including the automated intent mapping process and the runtime query processing workflow.

In an implementation, interface 706 provides input/output capabilities for the computing device 700. Interface 706 may include network interfaces for communicating with web applications to be analyzed, intercepting API calls, and delivering rendered widgets to users. The interface 706 may facilitate user interactions through chatbots or search interfaces, allowing users to express their intents in natural language. Interface 706 may connect display devices for rendering the widgets. In implementations where the system is distributed across multiple devices, interface 706 enables communication between the components of the intent-based user interface orchestration system.

The interface 706 may facilitate coupling computing device 700 to a network (e.g., a local area network, the Internet, or any other type of network) to access web applications for analysis and to deliver rendered widgets to users. Interface 706 may perform or facilitate the receipt or transmission of wired or wireless communications using various protocols and technologies, allowing the intent-based user interface orchestration system to operate across diverse network environments.

The computing device 700 can implement the methods described in FIGS. 3, 4, and 5 through various instructions stored in memory 704 and executed by processor 702. These instructions may include auto-crawling instructions that trigger the systematic visiting of web application pages; DOM parsing instructions that extract semantic content from HTML elements; intent generation instructions that create intent candidates from extracted tags; API interception instructions that capture metadata about API calls; intent recognition instructions that match user queries to stored intents; parameter filling instructions that extract and apply parameters; API execution instructions that construct and execute API requests; and widget rendering instructions that display the appropriate widgets.

The plug-and-play nature of the intent-based user interface orchestration system is achieved through the coordinated execution of these instructions by processor 702, with the resulting mappings and data stored in memory 704 and the user interactions facilitated through interface 706. The zero-coding approach, automated intent-API-widget mapping, and widget precision described in previous figures are all implemented through specific instruction sets that work together to create a seamless, adaptive system that responds accurately to user intents without requiring manual configuration or domain expertise.

Methods described herein can be implemented using computer-executable instructions stored in memory 704 or otherwise available from computer-readable media. Such instructions can include, for example, instructions that cause processor 702 to perform the steps of methods 300 and 400, or to implement the interactions shown in sequence diagram 500. The computer-executable instructions may be, for example, binaries, intermediate format instructions, firmware, or source code that implements the intent-based user interface orchestration system's capabilities.

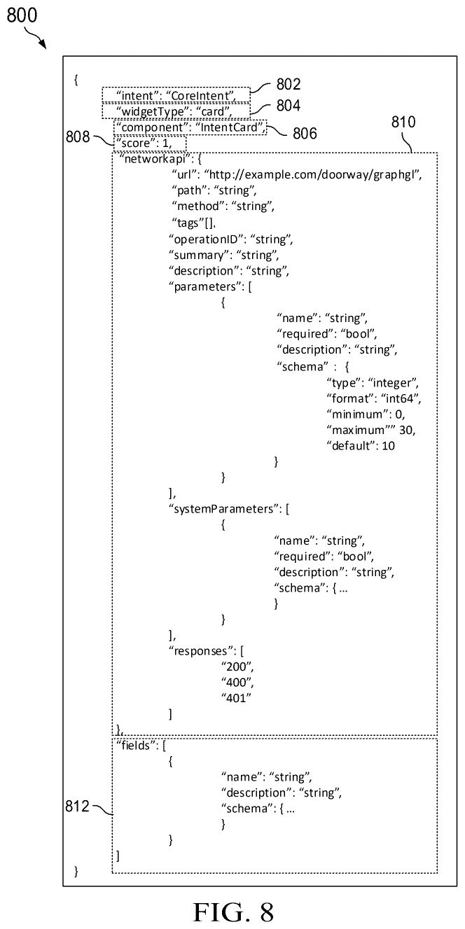

FIG. 8 illustrates an example data structure 800 representing the format of information stored in the metadata store after the auto crawler extracts semantic cues from a web application interface and performs network interception, according to an implementation of the disclosure. The data structure 800 includes an intent field 802, a widget type field 804, a component field 806, a score field 808, a network API field 810, and a field definition 812.

The data structure is shown in JavaScript Object Notation (JSON) format and contains mappings between user intent, widget type, and API details. The structure includes fields such as intent field 802 (identifying the intent as “CoreIntent”), widgetType field 804 (specifying the visual representation as a “card”), component field 806 (identifying the specific component as “IntentCard”), and score field 808 (indicating the relevance or priority of this mapping). The networkapi field 810 contains detailed information about the associated API, including the URL, path, method, operationID (e.g., operation name, API ID), and parameters. The parameter definitions include information about data types, validation constraints (minimum and maximum values), and default values. The “networkapi” field 810 sections for system parameters and expected response codes. The instructions further include field definition 812, creating a comprehensive mapping that enables the system to correctly match user intents to appropriate APIs and widgets.

The data structure shown in FIG. 8 is provided as an example and is not necessarily intended to be limiting. Other data formats, structures, or storage mechanisms that achieve similar results are contemplated within the scope of the disclosure. For example, the metadata may be stored in different formats such as XML, YAML, in a relational database, graph database, or other storage systems. The specific fields, nesting structure, and naming conventions may vary based on implementation details, while still maintaining the fundamental intent-API-widget mapping relationships that enable the system's functionality.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A system for intent-based user interface orchestration, the system comprising a first computing device, the first computing device including:
a first processor; and
a first non-transitory memory storage comprising first instructions that, when executed by the first processor, cause the first computing device to:
trigger an auto-crawler to systematically visit pages of a web application,
parse, using a parser, dashboard information from the web application to extract semantic content from interface elements,
intercept Application Programming Interface (API) calls during page interactions to capture API metadata,
generate intent candidates from the extracted semantic content,
establish mappings to APIs and widgets, and
store the intent candidates, API metadata, and mappings in a metadata store.

2. The system of claim 1, further comprising a second computing device, the second computing device including:
a second processor; and
a second non-transitory memory storage comprising second instructions that, when executed by the second processor, cause the second computing device to:
identify an intent from a natural language query received from a user,
retrieve a mapped API and a widget corresponding to the identified intent from the metadata store, and
render the widget based on a response from an executed API, wherein the mapped API is executed with parameters extracted from the natural language query to generated the executed API.

3. The system of claim 2, wherein the first computing device and the second computing device are a same computing device.

4. The system of claim 2, wherein the first computing device is further caused to automatically update the mappings in the metadata store by detecting changes in DOM structure or identifying new API calls and triggering the auto-crawler to refresh the metadata store.

5. The system of claim 1, wherein the parser is a Document Object Model (DOM) parser, and wherein parsing the dashboard information comprises extracting text content from semantic tags including heading elements, emphasis elements, structural elements, or a combination thereof.

6. The system of claim 1, wherein generating the intent candidates comprises assigning scores to the extracted semantic content based on tag importance, wherein text within heading tags receives higher scores than text within standard paragraph elements.

7. The system of claim 1, wherein establishing mappings to APIs comprises matching extracted intent to an operation identifier or API name using semantic similarity algorithms, and wherein a mapping is created in response to a similarity score between the extracted intent and the operation identifier exceeding a defined threshold.

8. A computer-implemented method for intent-based user interface orchestration, comprising:
triggering an auto-crawler to systematically visit pages of a web application;
parsing dashboard information from the web application to extract semantic content from interface elements;
intercepting Application Programming Interface (API) calls during page interactions to capture API metadata;
generating intent candidates from the extracted semantic content and establishing mappings to APIs and widgets;
storing the intent candidates, API metadata, and mappings in a metadata store;
receiving a natural language query from a user;
identifying an intent from the natural language query;
retrieving a mapped API and a widget corresponding to the identified intent from the metadata store;
executing the mapped API with parameters extracted from the natural language query; and
rendering the widget based on a response from the executed API.

9. The method of claim 8, wherein parsing the dashboard information comprises, parsing, by a Document Object Model (DOM) parser, and wherein parsing the dashboard information comprises extracting text content from semantic tags including heading elements, emphasis elements, structural elements, or a combination thereof.

10. The method of claim 8, wherein generating the intent candidates comprises assigning scores to the extracted semantic content based on tag importance, wherein text within heading tags receives higher scores than text within standard paragraph elements.

11. The method of claim 8, wherein establishing mappings to APIs comprises matching extracted intent to an operation identifier or API name using semantic similarity algorithms, and wherein a mapping is created in response to a similarity score between the extracted intent and the operation identifier exceeding a defined threshold.

12. The method of claim 8, further comprising automatically updating the mappings in the metadata store by detecting changes in DOM structure or identifying new API calls and triggering the auto-crawler to refresh the metadata store.

13. The method of claim 8, wherein identifying the intent from the natural language query comprises applying similarity scoring algorithms to match the natural language query to stored intent candidates.

14. The method of claim 8, wherein the widget is an enterprise widget, and wherein rendering the widget comprises maintaining interactive elements of the enterprise widget including hyperlinks and hover functionality as originally designed in the web application.

15. A non-transitory computer-readable media storing computer instructions, that when executed by a processor, cause the processor to:
trigger an auto-crawler to systematically visit pages of a web application;
parse dashboard information from the web application to extract semantic content from interface elements;
intercept Application Programming Interfaces (API) calls during page interactions to capture API metadata;
generate intent candidates from the extracted semantic content and establish mappings to APIs and widgets;
store the intent candidates, API metadata, and mappings in a metadata store;
receive a natural language query from a user;
identify an intent from the natural language query;
retrieve a mapped API and a widget corresponding to the identified intent from the metadata store;
execute the mapped API with parameters extracted from the natural language query; and
render the widget based on a response from the executed API.

16. The non-transitory computer-readable media of claim 15, wherein parsing the dashboard information comprises using a Document Object Model (DOM) parser to extract text content from semantic tags including heading elements, emphasis elements, structural elements, or a combination thereof.

17. The non-transitory computer-readable media of claim 15, wherein generating the intent candidates comprises assigning scores to the extracted semantic content based on tag importance, wherein text within heading tags receives higher scores than text within standard paragraph elements.

18. The non-transitory computer-readable media of claim 15, wherein establishing mappings to APIs comprises matching extracted intent to an operation identifier or API name using semantic similarity algorithms, and wherein a mapping is created in response to a similarity score between the extracted intent and the operation identifier exceeding a defined threshold.

19. The non-transitory computer-readable media of claim 15, wherein the computer instructions, when executed by the processor, cause the processor to automatically updating the mappings in the metadata store by detecting changes in DOM structure or identifying new API calls and triggering the auto-crawler to refresh the metadata store.

20. The non-transitory computer-readable media of claim 15, wherein the widget is an enterprise widget, and wherein rendering the widget comprises maintaining interactive elements of the enterprise widget including hyperlinks and hover functionality as originally designed in the web application while preserving context-specific visualizations based on the identified intent.
